(19) United States
(12) Patent Application Publication
(10) Pub. No.: US 2018/0064070 A1
(43) Pub. Date: Mar. 8, 2018

(54) ACTIVITY DEVICE FOR USE IN POULTRY MANAGEMENT AND/OR REARING AND METHOD OF REARING AND/OR MANAGING POULTRY

(71) Applicant: BIG DUTCHMAN INTERNATIONAL GmbH, VECHTA (DE)

(72) Inventor: Holger Brunnberg, Osnabruck (DE)

(73) Assignee: BIG DUTCHMAN INTERNATIONAL GmbH, VECHTA (DE)

(21) Appl. No.: 15/690,388

(22) Filed: Aug. 30, 2017

(30) Foreign Application Priority Data
Sep. 6, 2016 (DE) 202016104912.1

(51) Int. Cl. A01K 45/00; A01K 39/014; A01K 31/18

(52) U.S. Cl. CPC A01K 45/00; A01K 31/18; A01K 39/014

(57) ABSTRACT

The invention relates to an activity device for use in poultry management and/or rearing, an activity system, an animal house, in particular for rearing and/or managing poultry, and a method of rearing and/or managing poultry. The present invention relates in particular to an activity device for use in poultry management and/or rearing comprising a material container with at least one material inlet, and at least one pecking opening, a pecking pan for receiving pecking material comprising at least one abrasion section having an abrasion enhancing surface, wherein the material container is arranged and designed to guide pecking material from the material inlet to the pecking opening, and wherein the pecking opening is arranged and designed in such a way that pecking material in the material container is prevented from falling out of the pecking opening due to gravity.

### CROSS-REFERENCE TO FOREIGN PRIORITY APPLICATION

The present application claims the benefit under 35 U.S.C._§ 119(b) of German Application No. DE 20 2016 104912.1 filed Sep. 6, 2016, titled “Activity Device for Use in Poultry Management and/or Rearing and Method of Rearing and/or Managing Poultry.”

### FIELD OF THE INVENTION

The invention relates to an activity device for use in poultry management and/or rearing, an activity system, an animal house, in particular for rearing and/or managing poultry, and a method of rearing and/or managing poultry.

### BACKGROUND OF THE INVENTION

In poultry management, for example in the case of chickens and in the case of laying hens, in particular, the phenomenon of feather pecking and cannibalism may occur. Especially in poultry herds whose beaks have not been trimmed and/or debeaked or not been trimmed and/or debeaked sufficiently, feather pecking and/or cannibalism may have negative consequences for poultry rearing and/or management. There are many factors contributing to the causes of feather pecking and/or cannibalism, wherein especially stress, a lack of entertainment options, unfavorable conditions with regard to house climate, feed and water or light management, a too high density of animals and/or generally unfavorable management conditions have been identified as particular causes. Furthermore, feather pecking leads in the suffering of animal which might even lead to death.

One option for preventing this misbehavior in poultry and for increasing the wellbeing of the animals is to provide activity material or entertainment options, respectively, to the poultry. As a general rule, such entertainment is to stimulate the foraging behavior of the poultry; arise the poultry's curiosity; if applicable, abrade the sharp beaks of the poultry; and, as far as possible, not replace the standard feed or only to a small extent. Currently, the entertainment options in on-floor, free-range, or organic management are usually located in the litter walkway so that the poultry can only access them when they are outside of an aviary installation.

Currently, pecking blocks, racks, and/or plastic elements are used as entertainment options and/or activity material. Pecking blocks may consist of or comprise various materials, such as sand lime bricks or mineral compounds specifically developed for the use in poultry management. Such pecking blocks are usually arranged in the litter area of an animal house, wherein said arrangement is usually either a suspended arrangement or a standing arrangement. The poultry will usually peck at such pecking blocks, which gives them the opportunity to satisfy their natural pecking need. Through this pecking, the poultry wear down their beaks so that they are less sharp-edged.

The disadvantage of pecking blocks in poultry management is, in most cases, their quickly decreasing attractiveness. The pecking block is a rather static activity element, which, moreover, merely means that other poultry are also animated to peck at it. In addition, the poultry tend to leave their excrements on the pecking blocks so that the health of the poultry may be jeopardized by the pecking blocks. In another version of pecking blocks, said pecking blocks consist or comprise mineral feed. Compared to the pecking blocks mentioned above, such a pecking block made of mineral feed has the advantage that it can also be regarded as feed by the poultry. However, pecking blocks made of mineral feed are also characterized by only providing little animation for the poultry to peck and/or to perform scrabble and search activities.

Racks are baskets filled with hay, straw, or similar material and are usually erected or suspended in the litter walkways. The racks are arranged and designed in such a way that the poultry can pick out the material in the racks. If filled regularly, the rack is slightly more attractive than a pecking block, since the poultry can regularly obtain new activity material. On the other hand, however, the rack does not have any effect on the beak abrasion and the material in the racks does not remain attractive to the poultry in the long term. As an alternative to racks, hay or straw balls may also be arranged in the litter area, wherein with regard to the disadvantages, the same disadvantages exist as in the case of conventional racks.

Plastic elements are distributed in the litter area in a suspended and/or standing manner. Plastic elements may for example be configured as canisters, chains, bands, or even buckets. However, plastic elements are characterized by being attractive to the poultry for only a short time.

The insufficient activity elements and the disadvantages for the poultry mentioned above will usually result in a higher mortality and reduced productivity of the surviving poultry. Both effects have the result that the poultry management costs increase and that the animal wellbeing is impacted. Moreover, in many jurisdictions, trimming poultry beaks is only possible to a limited extent or not possible at all.

It is therefore an object of the present invention to provide an activity device for use in poultry management and/or rearing, an activity system, an animal house, in particular for the rearing and/or management of poultry, and a method of rearing and/or managing poultry which reduce or eliminate one or several of the above mentioned disadvantages. It is, in particular, an object of the invention to provide a solution which reduces or eliminates the mortality of poultry in a poultry management and/or rearing farm. Furthermore, it is an object of the present invention to provide a solution which allows for species appropriate poultry management and/or rearing. In addition, it is an object of the present invention to provide a solution which increases the productivity of a poultry management and/or rearing farm.

### SUMMARY OF THE INVENTION

Pursuant to a first aspect of the present invention, the object mentioned above is achieved by means of an activity device for use in poultry management and/or rearing, in particular of chickens, comprising a material container with at least one material inlet, and at least one pecking opening, a pecking pan for receiving pecking material comprising at least one abrasion section having an abrasion enhancing surface, wherein the material container is arranged and designed to guide pecking material from the material inlet to the pecking opening, and wherein the pecking opening is arranged and designed in such a way that pecking material in the material container is prevented from falling out of the pecking opening due to gravity.

The invention is based on the insight that species appropriate management, reduced feather pecking, and reduced mortality can be achieved by combining the functions of pecking and beak abrasion with an increased foraging behavior and permanent availability. Through their own pecking, discovery, and play activities, the poultry release individual pecking material from the material container by pecking into the pecking opening. During use, the pecking opening preferably comprises a vertical entry area. The released pecking material reaches the pecking pan, for example, through pecking in the pecking opening so that the poultry can ingest the pecking material on the pecking pan equipped with a surface of abrasion enhancing coating. The material of the abrasion enhancing surface preferably has a material density which is higher than the material density of poultry beaks.

As a result, the ingestion of feed is made more interesting and, therefore, more attractive to the poultry, and the poultry will occupy themselves for longer with the activity device pursuant to the invention. Due to the fact that the poultry reward themselves for their exploration behavior, the incentive to use the device is permanently there. The abrasion enhancing surface enhances the natural abrasion of the poultry beak, which, in nature, is usually achieved through tedious foraging activities. The option to provide an activity device pursuant to the invention in very small design sizes makes it possible to arrange a plurality of activity devices in an aviary installation so all poultry have access to the devices, not only the dominant and high-ranking poultry.

Preferably, the material container comprises a wall, wherein at least one material inlet and/or at least one pecking opening can be arranged in said wall. It is particularly preferable for the pecking opening to be arranged and designed in such a way that the poultry, in particular, a chicken, can reach a pecking material in a hollow space on the inside of the material container. Furthermore, it is preferable that the pecking opening is designed as a through opening in an external wall of the material container. Through such through openings, the poultry, in particular, chickens, can at least partially enter the hollow space of the material container with their beaks and, thus, reach the pecking material.

In a preferred embodiment of the activity device, it is further required that the outside wall or a section of the outside wall, in particular, the section of the outside wall comprising the pecking opening, of the material container has essentially a tube-shaped, a ball-shaped, or a cone-shaped design. In addition, it may be preferable that a cross section of the material container or a section of the material container, in particular, the section of the material container comprising the pecking opening, is arranged orthogonally to the main extension direction with an essentially round, oval, triangle, or polygonal design. It is furthermore preferable that the hollow space of the material container formed by the outside wall or a section of the hollow space of the material container, in particular, the section of the material container comprising the pecking opening, has an essential cylindrical, cuboid-, ball, or cone-shaped design.

It is, in particular, preferable that the material container has a tube-shaped geometry, that the material inlet is arranged at the end of said tube-shaped material container, that the end opposite to said end is essentially closed, and that the pecking opening is arranged at the radial peripheral surface of this tube-shaped material container. In a preferred embodiment of the activity device it is furthermore required that the material container is connected to the pecking pan, wherein the material container is preferably arranged centered, preferably coaxially, at the picking bowl. The picking bowl may, for example, also be used to close the end of a material container with a tube-shaped design facing the pecking pan. In another preferred embodiment of the activity device it is required that the material container has two or more material inlets.

Due to the design of the pecking opening pursuant to the invention, essentially no pecking material contained in the material container will escape from the material container. In order for pecking material contained in the material container to fall out of the material container, in particular, an external activity is required, which may, for example, be executed through the pecking with the beak of a poultry animal. This means that when the material container is filled or being filled with a pecking material, said material will essentially not independently exit again through the pecking openings. In turn, this has the result that, during the operation of the activity device, a poultry animal, in particular, a chicken, must peck with a beak in a pecking opening in order to obtain the pecking material. However, as a general rule, the pecking material cannot be picked up by the poultry directly from the pecking opening, but falls down onto the pecking pan. From there, the poultry can aim for the pecking material and pick it up in a targeted manner. By aiming for the pecking material, of which, due to the design of the pecking opening, only small amounts are arranged on the pecking pan, in a targeted manner, the beak of the poultry will usually come into contact with the abrasion enhancing surface of the pecking pan so that the beak of the poultry is abraded on said surface and sharp edges are thus reduced. The prevention of pecking material falling out of the pecking opening due to gravity can be realized, for example, by means of a respective geometry of the pecking opening. It is, in particular, preferred that the pecking opening has extremely small dimensions so that the pecking material has a larger size than the pecking opening. In addition, further elements preventing the pecking material from falling out can be provided, for example, bristles or elastic materials.

Another preferred embodiment of the device is characterized in that the material container comprises two or more pecking openings. Such an embodiment of the activity device has, in particular, the advantage that a plurality of poultry animals can simultaneously use the activity device. Thus, the competition between the poultry animals is further reduced. The two or more pecking openings arranged at the material container may have the same design, respectively, with regard to size, geometry, and other characteristics. Alternatively, the two or more pecking openings preferably have different geometries, dimensions and other characteristics.

Furthermore, it is preferably required that the pecking opening has an essentially slot-shaped cross section orthogonal to an opening direction with a main extension direction and a secondary extension direction arranged orthogonal to the former, wherein during operation, the secondary extension direction is preferably arranged essentially horizontally and its extension furthermore preferably increases in the direction of the pecking pan. The main extension direction is characterized in that it comprises the largest dimensions of the extension. The secondary extension direction is arranged orthogonally to the main extension direction and, thus, forms the second extension of the pecking opening cross section.

Pursuant to this embodiment, during operation, the secondary extension direction preferably extends horizontally, so that, during operation, the main extension direction extends essentially vertically. Thus, the pecking opening has a first end and a second end, wherein the main extension of the pecking opening extends from the first end to the second end. It is furthermore preferred that the secondary extension direction at the first end has different dimensions than the secondary extension direction at the second end. It is particularly preferred that the first end is facing the pecking pan and the second end is facing away from the pecking pan, and that the extension in the secondary extension direction at the first end is larger than the extension of the secondary extension direction at the second end. Furthermore, the extension in the secondary extension direction of the slot-shaped cross section of the pecking opening may preferably be consistent. Furthermore, at the second end, the pecking opening preferably has a semicircular closure.

Another particularly preferred embodiment of the activity device requires that the pecking opening extends to an end of the material container facing the pecking pan. In a particularly preferred further embodiment of the activity device it is required that an end of the material container facing the pecking pan is arranged at a distance from the pecking pan in the area of the pecking opening. In this embodiment, preferably a clearance height is arranged between the pecking pan and the material container. It is particularly preferred that the distance of the end of the material container, in particular, in the area of the pecking opening, from the pecking pan is less than 20 mm, preferably less than 15 mm, furthermore preferably less than 10 mm, particularly preferably less than 6 mm, furthermore preferably less than or equal to 4 mm.

Pursuant to another particularly preferred embodiment of the activity device, it is required that the secondary extension direction has dimensions of less than 8 mm, preferably less than 6 mm, in particular preferably less than 4 mm, furthermore preferably less than 2 mm, and/or that, during operation, the main extension direction is arranged vertically and, preferably, has dimensions of more than 2 mm, preferably more than 4 mm, in particular preferably more than 6 mm, furthermore preferably more than 10 mm, moreover preferably more than 20 mm, further preferably more than 30 mm.

Another preferred embodiment of the activity device is characterized in that the pecking opening has an essentially round cross section orthogonal to an opening direction and the essentially round cross section has a diameter of less than 8 mm, preferably less than 6 mm, particularly preferably less than 4 mm, furthermore preferably less than 2 mm.

It is furthermore preferred that the material inlet is arranged and designed to be coupled with a conveyor system, wherein said coupling is preferably performed by means of a coupling unit, which is furthermore preferably arranged at the material container. Such a coupling unit may, for example, be designed to connect the activity device with a drag auger, which is arranged in a tube-shaped conveyor system. Alternatively, it is preferred that the coupling unit connects the activity device with a conveyor system configured as a feeding trough.

Another preferred embodiment of the activity device requires that the activity device comprises a distributor element of which at least sections protrude into the material container and which is designed to guide a pecking material to the at least one pecking opening, wherein the distributor element preferably has a cone-shaped geometry and, furthermore preferably, is arranged at the pecking pan. Furthermore, it is preferable that the distributor element, in particular the distributor element with the cone-shaped geometry, the material container and the pecking pan are coaxially arranged. A distributor element has the special advantage that the pecking material in the material container cannot become stale so that said pecking material is essentially offered to the poultry when it is fresh. Furthermore, it is preferably required that the distributor element, in particular, a cone-shaped distributor element, is arranged inside the material container and that it is arranged and designed to guide a pecking material to a pecking opening which is arranged at the end of the material container not facing the pecking pan.

Pursuant to another preferred embodiment of the activity device, it is required that the abrasion section comprises at least one dividing element, which divides the abrasion section into two or more partial abrasion sections. Preferably, a pecking opening is assigned to each partial abrasion section. It is particularly preferable that the number of the pecking openings is identical to the number of the partial abrasion sections. Furthermore, it is preferable that twice as many pecking orders than partial abrasion sections are arranged. Furthermore, it is preferable that three or more pecking openings are arranged per partial abrasion section.

Another particularly preferred embodiment of the activity device is characterized in that the abrasion enhancing surface of the abrasion section comprises at least one abrasion material or a combination of two or more abrasion materials, which is or are preferably chosen from the group consisting of metal, in particular, steel, ceramic, plastic, corundum, boron nitride, diamond, and minerals.

Furthermore, it is preferably required that, during operation, a main extension direction of the activity device has dimensions of less than 200 mm, preferably less than 150 mm, particularly preferably of less than 120 mm, furthermore preferably of less than 100 mm in horizontal direction.

Furthermore, it is preferably required that a main extension direction and/or a cross section of the pecking pan has dimensions of less than 200 mm, preferably less than 150 mm, particularly preferably of less than 120 mm, furthermore preferably of less than 100 mm.

In a preferred further embodiment of the activity device it is required that the pecking pan has a plate-shaped geometry with a preferably circular, oval, or square cross section. Furthermore, it is preferred that the pecking pan and/or the material container comprises or consists of metal, plastic, and/or ceramic.

Pursuant to another aspect of the invention, the above mentioned object is achieved by means of an activity system comprising at least one activity device pursuant to at least one of the above mentioned embodiments and a conveyor system for transporting pecking material, wherein the activity device is connected with the conveyor system via a coupling unit in such a way that pecking material is transported by the conveyor system into the material container, and wherein preferably during operation the horizontal dimensions of the activity device are smaller or equal to the respective horizontal dimensions of the conveyor system, in particular, transversally to the transport direction, in the area of the activity device. Due to the larger horizontal dimensions of the conveyor system compared to the horizontal dimensions of the activity device, the conveyor system covers the activity device in horizontal direction. Due to this covering of the activity device, for example, poultry excrements that are on the conveyor system cannot or, only to a reduced extent, get into or onto the activity device.

In addition, such an arrangement with an activity device with such dimensions is characterized in that it does not require a lot of space in an aviary installation. In particular, the space required is not larger than the space required for the existing conveyor system. This has the further advantage that the poultry have permanent access to the activity device, wherein this applies even to the early stage of the poultry in which the poultry might not be able, or only be able to a limited extent, to leave the aviary installation. Moreover, there are no peak hours at the activity devices, since the activity devices are always available. This further reduces conflict situations and stress for the poultry. In addition, such an arrangement provides even weak poultry animals, which might not be able, or only be able to a limited extent, to leave the installations, access to the activity device. Furthermore, the poultry animals do not have to compete for the activity device, or only to a limited extent. Due to the above described smaller dimensions of activity devices, a plurality of activity devices can be provided in an aviary installation so that, once again, there is less stress in the herd and, therefore, less conflict. Due to the dimensioning, even a plurality of arranged activity devices will not lead to any significant loss of space so that the usable space and, therefore, also the productivity of the management and/or rearing is not reduced or only reduced to a limited extent.

One preferred embodiment of the activity device is characterized in that the activity system comprises at least one feed pan for providing feed. As a pecking material for the activity device, feed, for example, may be used as well, wherein the big difference between a feed pan and the activity device pursuant to the invention is the provision of the pecking material and/or feed. A feed pan is flooded at a certain time with feed, and the poultry can pick up the feed without any major effort directly from the feed pan. The activity device, however, only provides pecking material, for example, in the form of feed, in highly limited amounts. Instead, the poultry must actively peck for the pecking material, which is inside the material container, and must subsequently pick up the thus-released feed from the abrasion enhancing surface of the pecking pan.

A combination of a feed pan and an activity device in an activity system has the further advantage that the conveyor system can be used for both devices.

It is, in particular, preferred that for one arranged feed pan at least one activity device, and/or at least two activity devices, and/or at least three activity devices, and/or at least four activity devices, and/or at least five activity devices, and/or at least ten activity devices, and/or at least fifteen activity devices, and/or at least twenty activity devices is and/or are arranged. Furthermore, it is preferred that between two neighboring feed pans at least one activity device, and/or at least two activity devices, and/or at least three activity devices, and/or at least four activity devices, and/or at least five activity devices, and/or at least ten activity devices, and/or at least fifteen activity devices, and/or at least twenty activity devices is and/or are arranged. It is furthermore preferred that the conveyor system is configured as a feeding trough and/or feed pipe.

Pursuant to another aspect of the present invention, the object mentioned above is achieved by means of an animal house, in particular, for rearing and/or management of poultry, in particular, chickens, comprising at least one aviary installation and a litter area, wherein inside the aviary installation at least one activity device pursuant to one of the above mentioned embodiments and/or an activity system pursuant to the aspect mentioned above is and/or are arranged.

Pursuant to another aspect of the present invention, the object mentioned above is achieved by means of a method for rearing and/or managing poultry, in particular chickens, comprising the steps of providing an activity device pursuant to at least one of the above mentioned embodiments and/or an activity system pursuant to at least one of the above mentioned embodiments, providing pecking material and arranging the pecking material inside a material container of the activity device. The method pursuant to the invention and its possible realizations comprise features or method steps, respectively, which make it, in particular, suitable for being used for an activity device pursuant to the invention and its embodiments. Regarding the further advantages, possible versions and realization details of these additional aspects and their realizations, reference is also made to the previous description of the respective features and embodiments of the activity device.

### BRIEF DESCRIPTION OF THE DRAWINGS

Preferred embodiments of the invention are, by way of example, described by means of the attached figures. The following is shown in

FIG. 1 is a schematic two-dimensional view of an exemplary embodiment of an activity system;

FIG. 2 is a schematic three-dimensional view of the activity system pursuant to FIG. 1;

FIG. 3 is a schematic two-dimensional view of another exemplary embodiment of an activity system;

FIG. 4 is a schematic two-dimensional view of an exemplary embodiment of an activity device;

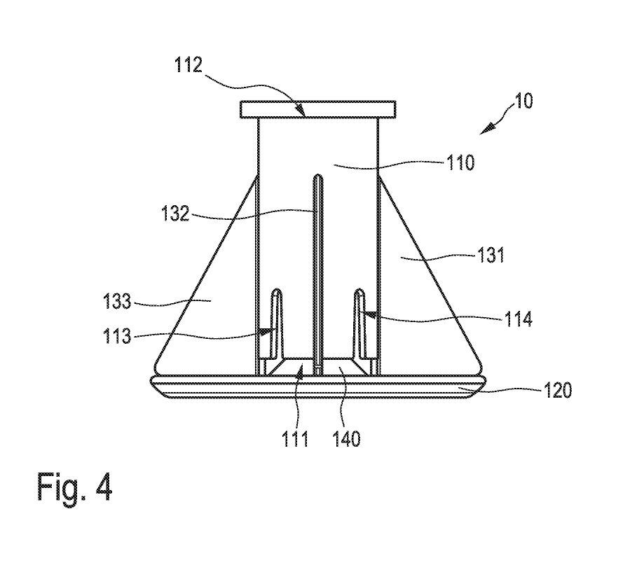

FIG. 5 is a schematic three-dimensional detailed view of a pecking opening of an activity device in accordance with the activity system pursuant to FIGS. 1 and 2;

FIG. 6 is a schematic three-dimensional detailed view of an activity device in accordance with the activity system pursuant to FIGS. 1 and 2;

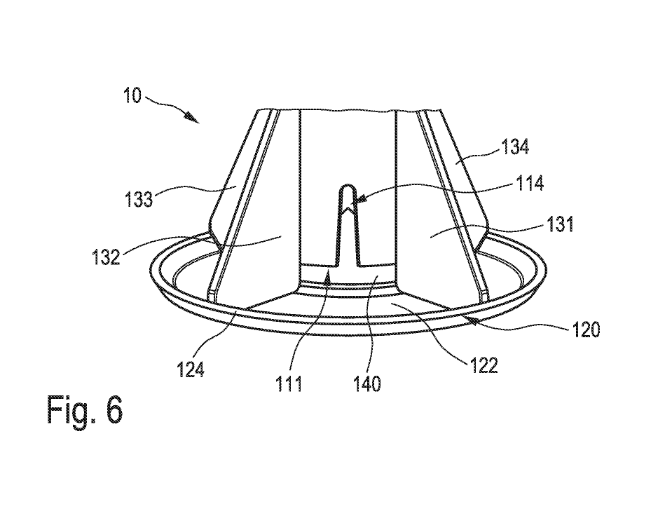

FIG. 7 is a schematic two-dimensional view of an aviary installation known in prior art;

FIG. 8 is an aviary installation pursuant to FIG. 7 during operation;

FIG. 9 is a schematic two-dimensional view of an aviary installation including an exemplary embodiment of an activity system;

FIG. 10 is an aviary installation pursuant to FIG. 9 during operation;

FIG. 11 is a schematic view of an animal house with two aviary installations known in prior art;

FIG. 12 is a schematic view of an exemplary embodiment of an animal house with two aviary installations, each comprising an exemplary embodiment of an activity system; and

FIG. 13 is a schematic view of an animal house with an activity option known in prior art.

### DETAILED DESCRIPTION OF THE PREFERRED EMBODIMENTS

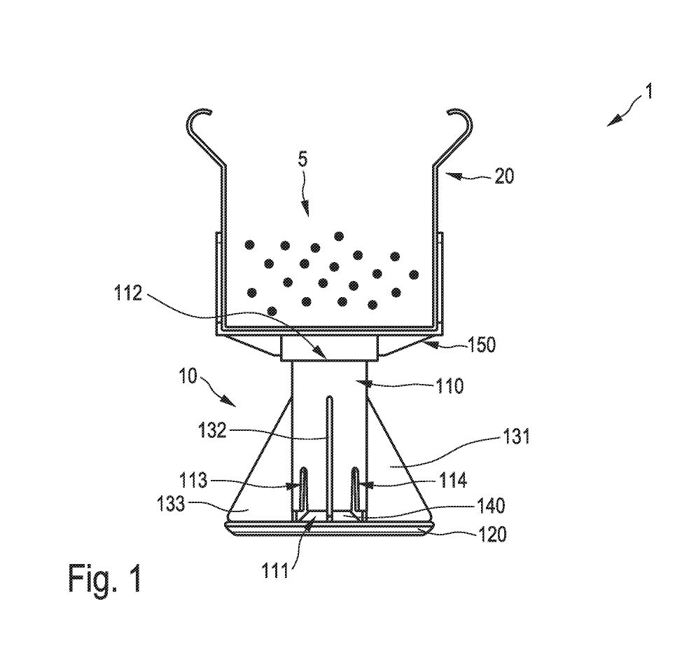

As referenced in the Figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in FIG. 1. However, it is to be understood that the present disclosure may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

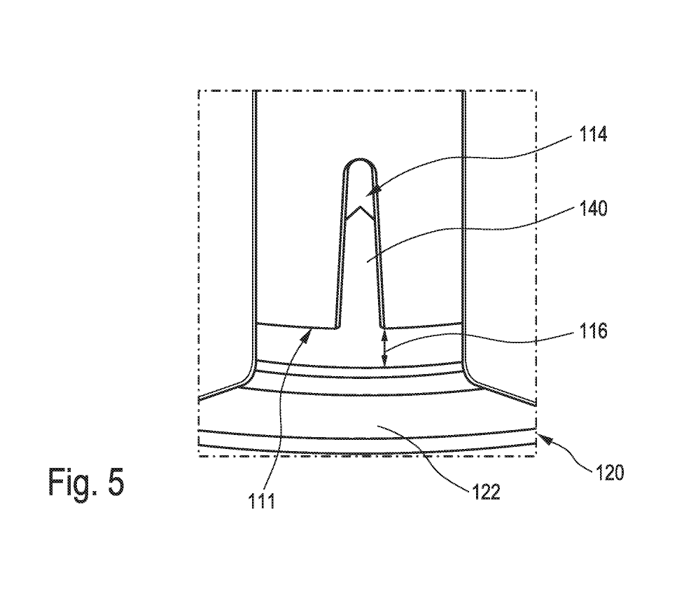

Identical elements or elements with essentially the same or similar function are referred to with the same reference number in the figures. The activity systems 1, 1′ shown in FIGS. 1-3 comprise an essentially identical activity device 10, respectively. The activity device 10 comprises a pecking pan 120, which has a planar extension, which is arranged horizontally in the displayed operating state. The material container 110 has a tube-shaped geometry. Due to this tube-shaped geometry, the material container 110 has an opening on each of its front faces, respectively. Furthermore, the material container 110 extends from a first end 111 to a second end 112. The first end 111 of the material container 110 is facing the pecking pan 120, wherein a distance 116, in particular shown in FIG. 5, is provided between the pecking pan 120 and the material container 110.

This arrangement is, in particular, designed in such a way that the center axis of the tube-shaped material container 110 is arranged orthogonally to the surface of the pecking pan 120. The arrangement of the material container 110 at the pecking pan 120 is achieved by means of a first dividing wall 131, a second dividing wall 132, a third dividing wall 133, and a fourth dividing wall 134. The dividing walls each have a planar extension, wherein this planar extension has the geometry of a right triangle. The dividing walls 131-134 are respectively arranged with the first leg at the pecking pan 120 and with the second leg at the exterior wall of the material container 110. Furthermore, the dividing walls 131-134 are arranged at equal distances from each other in the circumference direction of the tube-shaped material container 110. Thus, the material container 110 is arranged between the dividing walls 131-134 and is held by them at the predefined distance 116 above the pecking pan 120.

Furthermore, the activity device 10 comprises a total of four pecking openings, of which merely two pecking openings 113, 114 are shown in FIG. 1. The pecking openings 113, 114 have an essentially slot-shaped cross section orthogonal to an opening direction. Furthermore, the slot-shaped cross section has a main extension direction and a secondary extension direction arranged orthogonal to the former. The main extension direction, which, in the present example, is arranged vertically and, therefore, parallel to a longitudinal axis of the material container 110, has dimensions which exceed the dimensions of the secondary extension direction multiple times. Furthermore, the pecking openings 113, 114 have a main extension in the main extension direction between a first end, which faces the pecking pan 120, and a second end, which faces the conveyor system 205. The dimensions of the pecking openings 113, 114 in the secondary extension continuously decrease from the first end to the second end. The second end also has a semicircular geometry.

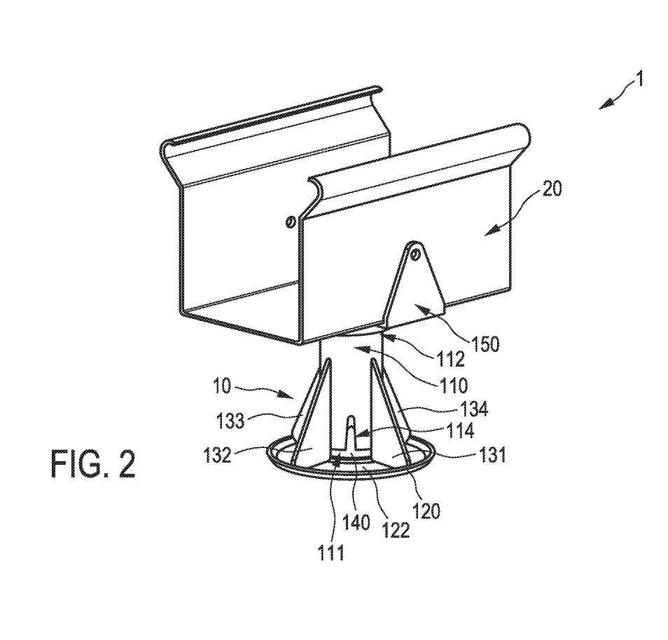

As can be seen in FIGS. 2 and 5, in particular, the diameter of the material container 110 is smaller than the diameter of the pecking pan 120. The ring-shaped area between the outer wall of the pecking pan 120 and the material container 110, which is, therefore, left free, has an abrasion-enhancing material so that an abrasion section 122 is formed in this area. Furthermore, the dividing walls 131-134 divide this abrasion section 122 into four partial abrasion sections. Furthermore, the plate-shaped geometry of the pecking pan 120 has a pecking pan rim 124, which leads to the result that pecking material falling from the pecking opening 113, 114 onto the pecking pan 120 essentially remains in the pan 120.

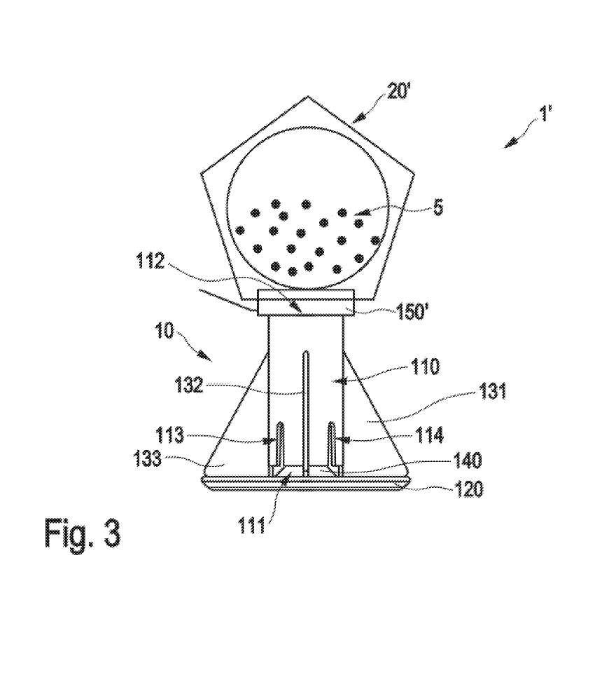

The difference between the activity systems 1, 1′ shown in FIGS. 1 and 3 is, in particular, the design of the conveyor systems 20, 20′, which are configured to transport pecking material 5. The conveyor systems 20, 20′ are respectively arranged at the front face of the second end of the material container. The activity system 1 of FIG. 1 is designed as a feeding trough, which has a rectangular cross section orthogonal to the transport direction. The activity system 1′ shown in FIG. 3 comprises a conveyor tube with a drag auger (not shown), which has an essentially circular cross section orthogonal to the transport direction.

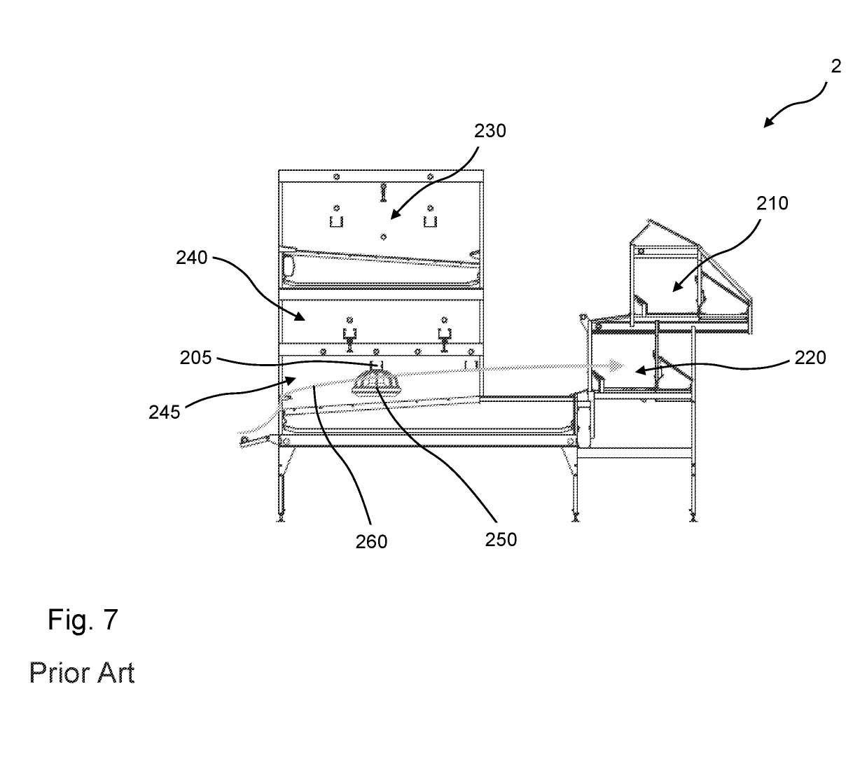

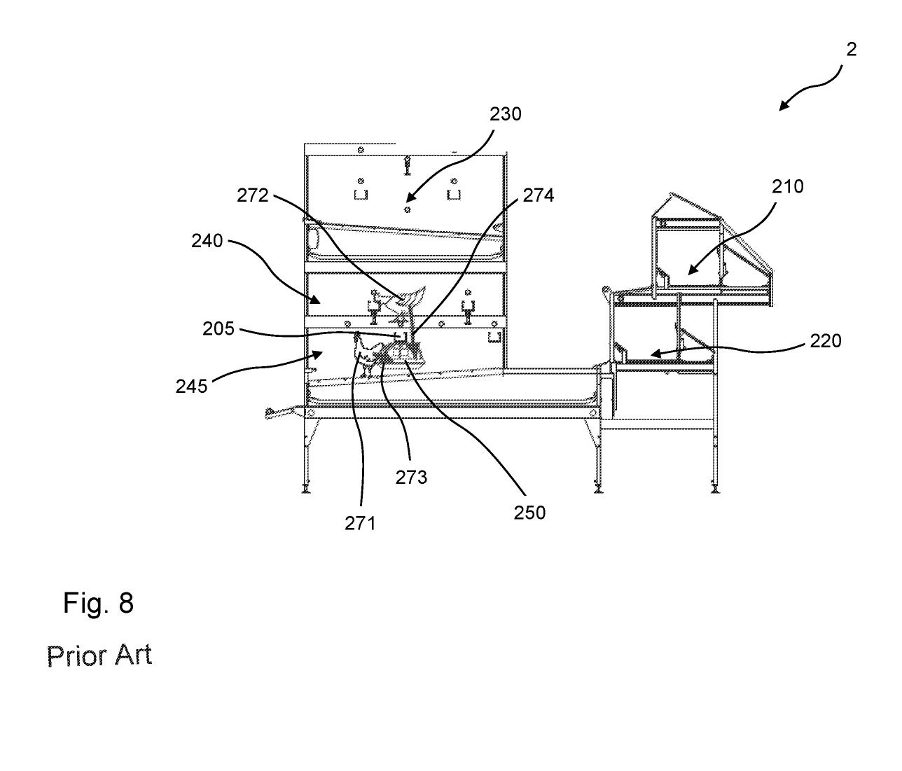

The aviary installations already known in the prior art, as shown in FIGS. 7 and 8, comprise a first nest 210 and a second nest 220, which, in particular, are designed to provide poultry with a space for laying eggs. In addition, at a distance from the nests 210, 220, the aviary installation 2 has a first holding area 230 and a second holding area 240. The first holding area 230 is arranged vertically above the second holding area 240, wherein a passage area 245 with a feed pan 250 is arranged below the second holding area 240. The passage area 245 is, in particular, arranged and designed to allow the poultry passage to the nests 210, 220. Presently, a feed pan 250 is arranged in the passage area 245. Especially FIG. 8 shows that the feed pan 250 is arranged in such a way that it has a plurality of disadvantages. First, the feed pan 250, as a large component, is arranged in the passage area 245 and blocks and/or restricts passage for the poultry and the capacity of the aviary installation 2 is reduced by the feed pan 250. In addition, FIG. 8 shows that excrements 273, 274 of the poultry 271, 272 can easily end up in the feed pan 250.

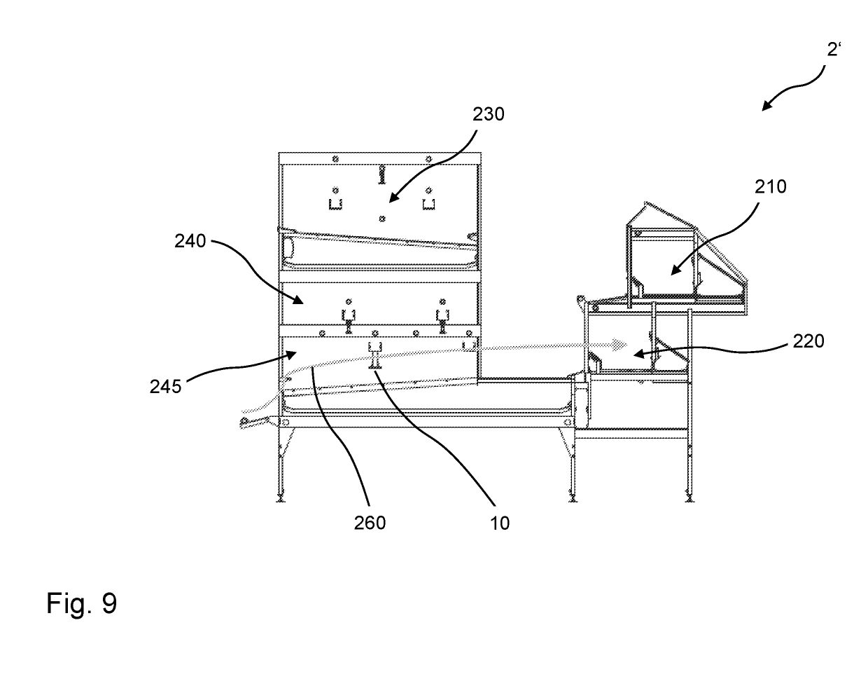

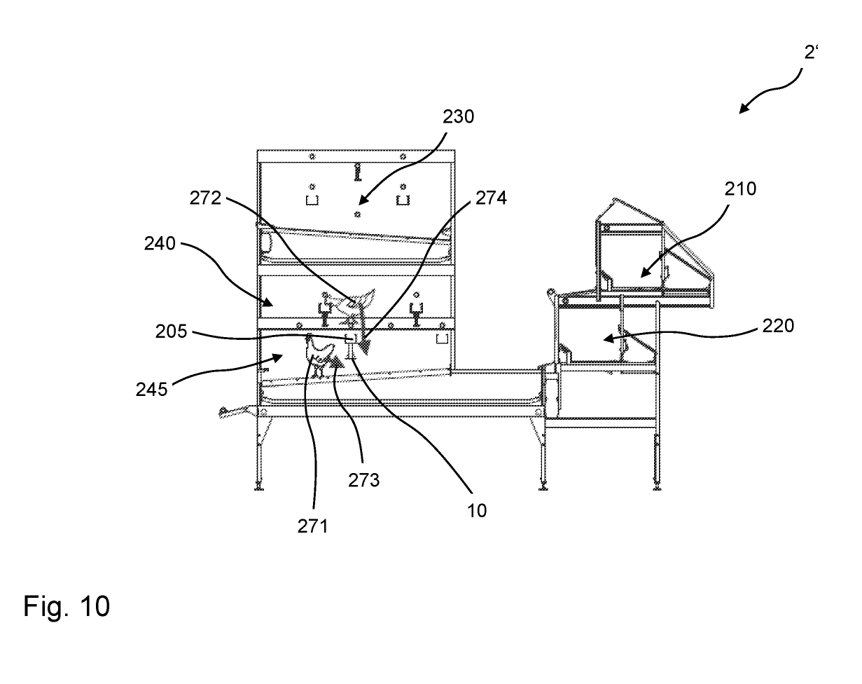

The aviary installations with the activity devices 10 or activity systems, respectively, shown in FIGS. 9 and 10 show that with their compact dimensions the activity devices 10 do not present an obstacle for the poultry in the passage area 245. Furthermore, as can be seen in FIG. 10, in particular, due to the compact dimensions of the activity device 10, no or merely a limited amount of excrements of the poultry 271, 272 ends up in the activity device 10. The reason for this is, inter alia, that the horizontal dimensions of the activity device 10 are smaller than the horizontal dimensions of the conveyor system 205.

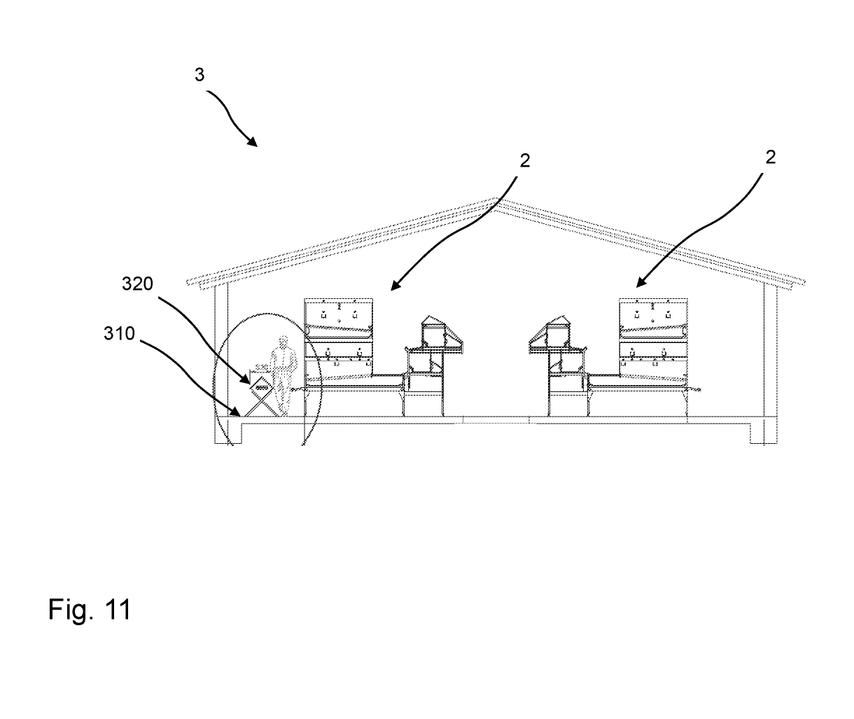

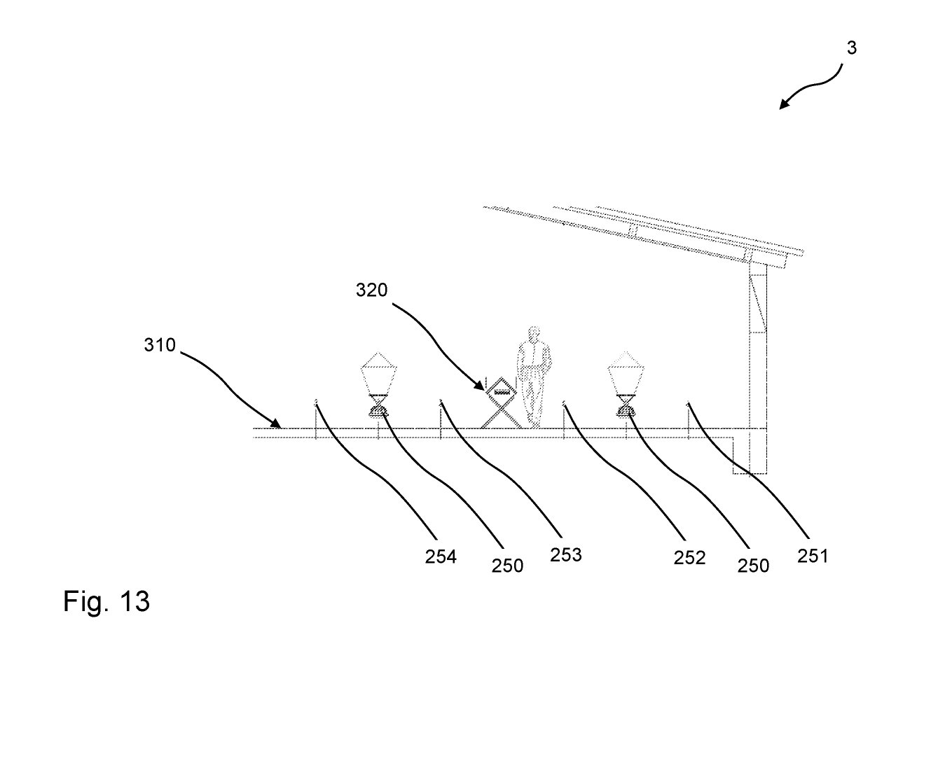

FIG. 11 shows an animal house 3 with a litter area 310 and two aviary installations 2 with identical design known in prior art. In addition, a rack 320 is located in the litter area 310 in animal house 3 which restricts or prevents passage for a person. FIG. 13 shows another area of the animal house 3, wherein said area comprises a total of four drinking troughs 251-254 as well as two feed pans 250. Furthermore, said area of the animal house 3 comprises a rack 320, which is arranged between the drinking troughs 252, 253. In this case as well, passage through the animal house is made difficult for a person, since only a small passage way is provided between the drinking trough 252 and the rack 320.

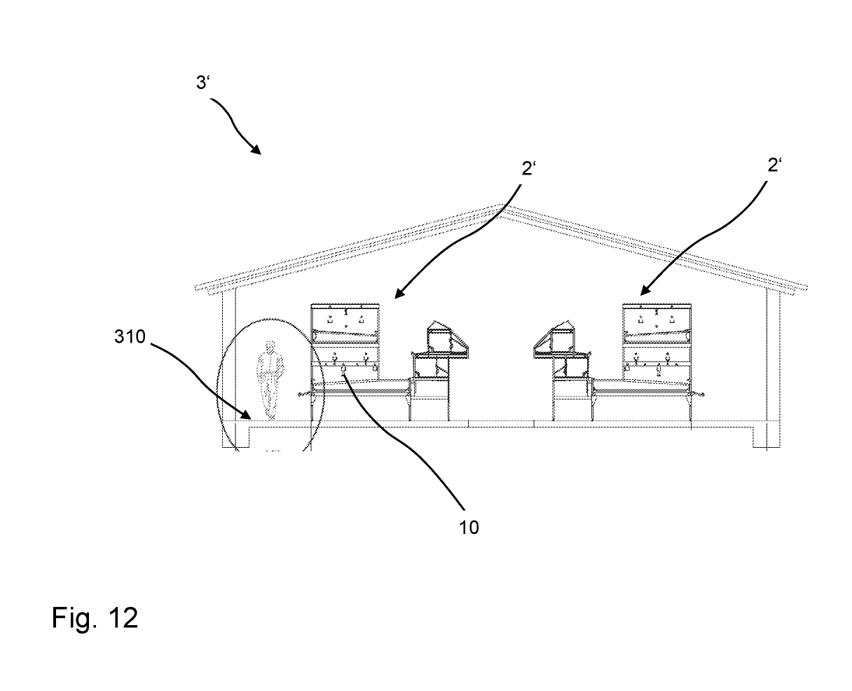

The animal house 3′ in FIG. 12 comprises two aviary installations 2′, each comprising an activity device 10 and/or an activity system, where no additional activity devices, for example, in the form of racks, are necessary in the litter area. Thus, a person is not prevented from passage through the litter area by an activity device so that daily work is made easier for the person working in the house.

An activity device 10 pursuant to the invention as well as its arrangement in an aviary installation 2′ and/or in an animal house 3′ has, in particular, the advantage that the poultry kept in said animal house will be less inclined to engage in feather pecking and less inclined to engage in cannibalism. Moreover, the work of the person working in the animal house is facilitated, since no activity options need to be arranged in the litter area. The poultry are continuously entertained by the activity device and, in addition, may also be provided with additional feed by means of the activity device. Furthermore, the activity device pursuant to the invention has, first of all, the result that due to the improved house climate and the thus-reduced stress of the poultry, feather pecking and/or cannibalism are reduced or prevented. Moreover, the beaks of the poultry are abraded due to the activity device pursuant to the invention so that, even if feather pecking occurs, only a small risk of injury exists.

It will be understood by one having ordinary skill in the art that construction of the described present disclosure and other components is not limited to any specific material. Other exemplary embodiments of the disclosure disclosed herein may be formed from a wide variety of materials, unless described otherwise herein.

For purposes of this disclosure, the term “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that many modifications are possible, e.g., variations in sizes, dimensions, structures, shapes and proportions of the various elements, values of parameters, mounting arrangements, use of materials, colors, orientations, etc. without materially departing from the novel teachings and advantages of the subject matter recited. For example, elements shown as integrally formed may be constructed of multiple parts or elements shown in multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of the wide variety of materials that provide sufficient strength or durability, in any of the wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure and method without departing from the concepts of the present disclosure, and further it is to be understood that such concepts are intended to be covered by the following claims unless these claims by their language expressly state otherwise.

1.-15. (canceled)

16. An activity device for use in poultry management and/or rearing comprising:
a material container with at least one material inlet and at least one pecking opening; and
a pecking pan for receiving pecking material, comprising at least one abrasion section having an abrasion enhancing surface;
wherein the material container is arranged and designed to guide pecking material from the material inlet to the pecking opening, and
wherein the pecking opening is arranged and designed in such a way that pecking material in the material container is prevented from falling out of the pecking opening due to gravity.

17. The activity device pursuant to claim 16, wherein the material container comprises two or more pecking openings.

18. The activity device pursuant to claim 16, wherein the pecking opening has an essentially slot-shaped cross section orthogonal to an opening direction with a main extension direction and a secondary extension direction arranged orthogonal to the former;
wherein during operation, the secondary extension direction is preferably arranged essentially horizontally and its extension furthermore preferably increases in the direction of the pecking pan.

19. The activity device pursuant to claim 16, wherein the pecking opening extends to an end of the material container facing the pecking pan.

20. The activity device pursuant to claim 19, wherein the end of the material container facing the pecking pan is arranged at a distance from the pecking pan in the area of the pecking opening.

21. The activity device pursuant to claim 18, wherein the secondary extension direction has dimensions of less than 8 mm.

22. The activity device pursuant to claim 18, wherein during operation, the main extension direction is arranged vertically and has dimensions of more than 2 mm.

23. The activity device pursuant to claim 16, wherein the pecking opening has an essentially round cross section orthogonal to an opening direction, and the essentially round cross section has a diameter of less than 8 mm.

24. The activity device pursuant to claim 16, wherein the material inlet is arranged and designed to be coupled with a conveyor system, wherein said coupling is performed by means of a coupling unit.

25. The activity device pursuant to claim 24, said coupling is arranged at the material container.

26. The activity device pursuant to claim 16, wherein the abrasion section comprises at least one dividing element that divides the abrasion section into two or more partial abrasion sections.

27. The activity device pursuant to claim 16, wherein the abrasion enhancing surface of the abrasion section comprises at least one abrasion material or a combination of two or more abrasion materials, the abrasion material(s) being chosen from the group consisting of metal, ceramic, plastic, corundum, boron nitride, diamond, or minerals.

28. The activity device pursuant to claim 27, wherein the abrasion material comprises steel.

29. The activity device pursuant to claim 16, wherein a main extension direction and/or a cross section of the pecking pan has dimensions of less than 200 mm.

30. The activity device pursuant to claim 16, wherein the pecking pan has a plate-shaped geometry with a circular, oval, or square cross section.

31. An activity system comprising:
at least one activity device pursuant to claim 16, and a conveyor system for transporting pecking material;
wherein the activity device is connected with the conveyor system via a coupling unit in such a way that pecking material is transported from the conveyor system into the material container, and
wherein during operation the horizontal dimensions of the activity device are smaller than or equal to the respective horizontal dimensions of the conveyor system in the area of the activity device.

32. The activity system pursuant to claim 31, further comprising at least one feed pan for providing feed.

33. An animal house for rearing and/or managing poultry, comprising:
at least one aviary installation; and
a litter area;
wherein the aviary installation containing at least one activity device pursuant to claim 16.

34. An animal house for rearing and/or managing poultry, comprising:
at least one aviary installation; and
a litter area;
wherein the aviary installation containing at least one activity system pursuant to claim 31.

35. A method for rearing and/or managing poultry, comprising the steps of:
providing an activity device pursuant to claim 16, providing pecking material and arranging the pecking material inside a material container of the activity device.

36. A method for rearing and/or managing poultry, comprising the steps of:
providing an activity system pursuant to claim 31, providing pecking material and arranging the pecking material inside a material container of the activity system.
